(19) United States
(12) Patent Application Publication
(10) Pub. No.: US 2010/0040795 A1
(43) Pub. Date: Feb. 18, 2010

(54) PROCESS FOR SEALING MICRO PORES OF MICRO-ARC OXIDE FILMS

(75) Inventors: FENG-YUEN DAI, Shindian (TW); CHWAN-HWA CHIANG, Shindian (TW); YUNG-TA LO, Shindian (TW); CHI-CHUANG HO, Shindian (TW); WEI LIU, Shenzhen City (CN); XU-FENG AO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/478,022

(22) Filed: Jun. 4, 2009

(30) Foreign Application Priority Data
Aug. 14, 2008 (CN) 200810303793.9

(51) Int. Cl. B05D 1/18

(52) U.S. Cl. 427/435

(57) ABSTRACT

A process for sealing micro pores of micro-arc oxide film is disclosed in the present disclosure. The process may comprise the following steps: providing a metal coated with a micro-arc oxide film; providing a dipping solution including polyester methacrylate monomer for use as a sealing agent; and dipping the metal in the sealing agent to form a coating on the oxide film's surface.

### CROSS-REFERENCE TO RELATED APPLICATIONS

This application is related to co-pending U.S. Patent Applications (Attorney Docket Nos. US20819, US23072, and US23073), all entitled “PROCESS FOR SEALING MICRO PORES OF MICRO-ARC OXIDE FILMS”. Such applications have the same assignee as the present application. The above-identified applications are incorporated herein by reference.

### BACKGROUND

1. Technical Field

The present disclosure relates to a process for sealing micro pores of micro-arc oxide films.

2. Description of Related Art

Micro-arc oxidation is a surface treatment process that oxidizes a metal's surface to form a micro-arc oxide film. Micro-arc oxide films have an attractive appearance, like ceramic, and possesses high rigidity. Micro-arc oxidation is widely used in the field of surface decoration.

When being treated by micro-arc oxidation at a high temperature, the metal substrate discharges gas through the oxide film formed on the surface, thereby forming a plurality of micro pores in the oxide film. The micro pores should be sealed to prevent the micro-arc oxide film from being contaminated by dirt or other impurity.

A typical process for sealing micro pores of micro-arc oxide film is similar to the process for sealing micro pores of an anode oxide film. However, the micro pores of the micro-arc oxide film are different from those of the anode oxide film in terms of physical dimensions and properties. Therefore, the sealing process for the anode oxide film has poor effect on the micro-arc oxide film. In addition, this sealing process may negatively affect the appearance of the micro-arc oxide film.

Therefore, there is room for improvement within the art.

### DETAILED DESCRIPTION

A process for sealing micro pores of micro-arc oxide films is disclosed in the present disclosure. The process may comprise at least the following steps: providing a piece of metal coated with a micro-arc oxide film; providing a dipping solution including polyester methacrylate monomer for use as a sealing agent; and dipping the metal in the sealing agent under substantially vacuum conditions (e.g. pressure of approximately 0.4-0.6 Pa) to form a coating on the oxide film's surface. Prior to dipping the metal in the sealing agent, the metal is placed in a vacuum chamber first. The vacuum chamber is then brought to substantially vacuum conditions. The metal may be in the vacuum chamber for about 30-60 minutes. Then, the sealing agent is introduced into the chamber to completely immerse the metal. The dipping process should last for about 30-60 minutes. During the dipping process, the sealing agent is partially absorbed into the micro pores of the micro-arc oxide film. After the dipping step, the metal is removed from the sealing agent. Any extra sealing agent adhering to the oxide film is removed by centrifuge. The metal is then baked in an oven at about 90-120° C. for about 30-60 minutes. The coating formed on the oxide film has a thickness of about 3.5˜4.5 μm.

### EXAMPLE 1

A piece of aluminum alloy coated with a micro-arc oxide film is provided. The micro-arc oxide film's surface roughness is about 1.29 μm. Then, the aluminum alloy is placed in a vacuum chamber for about 30 minutes (the vacuum chamber is brought to substantially vacuum conditions). After the aluminum alloy being in the vacuum chamber for about 30 minutes, a dipping solution including polyester methacrylate monomer is introduced into the chamber to completely immerse the aluminum alloy. The dipping process lasts for about 40 minutes. After the dipping step, the aluminum alloy is removed from the sealing agent. Any extra sealing agent adhering to the oxide film is removed by centrifuge. The aluminum alloy is then baked in an oven at about 100° C. for about 40 minutes to form a coating on the surface of the micro-arc oxide film. The surface roughness of the film changes to about 1.22 μm. The coating's thickness is about 4 μm. The oxide film's rigidity is about 610 HV. The micro-arc oxide film can pass smudge resistance testing after being treated by the sealing process.

### EXAMPLE 2

A piece of aluminum alloy coated with a micro-arc oxide film is provided. The micro-arc oxide film's surface roughness is about 1.25 μm. Then, the aluminum alloy is placed in a vacuum chamber for about 60 minutes (the vacuum chamber is brought to substantially vacuum conditions). After the aluminum alloy is in the vacuum chamber for about 60 minutes, a dipping solution including polyester methacrylate monomer is introdued into the chamber to completely immerse the aluminum alloy. The dipping process lasts for about 30 minutes. After the dipping step, the aluminum alloy is removed from the sealing agent. Any extra sealing agent adhering to the oxide film is removed by centrifuge. The aluminum alloy is then baked in an oven at about 120° C. for about 30 minutes to form a coating on the surface of the micro-arc oxide film. The surface roughness of the film changes to about 1.2 μm. The coating's thickness is about 3.6 μm. The oxide film's rigidity is about 620 HV The micro-arc oxide film can pass smudge resistance testing after being treated by the sealing process.

The process of sealing micro pores is fit for the micro-arc oxide film which is formed on aluminum alloy, magnesium alloy and titanium alloy.

The process of sealing micro pores of micro-arc oxide film will not affect the rigidity and the appearance of the film. It is appropriate for sealing micro pores of micro-arc oxide film.

It should be understood, however, that even though numerous characteristics and advantages of the present embodiments have been set forth in the foregoing description, together with details of functions of the embodiments, the disclosure is illustrative only, and changes may be made in detail, especially in matters of mass ratio of the sealing agent and laying or baking time within the principles of the invention to the full extent indicated by the broad general meaning of the terms in which the appended claims are expressed.

What is claimed is:

1. A process for sealing micro pores of micro-arc oxide films, comprising:
providing a metal coated with a micro-arc oxide film;
providing a dipping solution including polyester methacrylate monomer for use as a sealing agent;
dipping the metal in the sealing agent to form a coating on the oxide film's surface.

2. The process as claimed in claim 1, wherein the step of dipping the metal in the sealing agent is carried out under substantially vacuum conditions.

3. The process as claimed in claim 2, wherein the step of dipping lasts for about 30-60 minutes.

4. The process as claimed in claim 3, further comprising, after the dipping step, baking the metal in an oven at about 90-120° C. for about 30-60 minutes.

5. The process as claimed in claim 1, wherein the thickness of the coating is 3.5˜4.5 μm.

6. The process as claimed in claim 1, wherein the metal is selected from the group consisting of aluminum alloys, magnesium alloys and titanium alloys.
